(19) United States
(12) Patent Application Publication
(10) Pub. No.: US 2006/0286212 A1
(43) Pub. Date: Dec. 21, 2006

(54) Low moisture, low water activity caramel, caramel composite products and process for preparation

(76) Inventor: Weizhu Yu, Morris Plains, NJ (US)

Correspondence Address: THADDIUS J. CARVIS, 102 NORTH KING STREET, LEESBURG, VA, 20176, US

(21) Appl. No.: 11/146,473

(22) Filed: Jun. 7, 2005

(51) Int. Cl. A23G 3/00

(52) U.S. Cl. 426/94

(57) ABSTRACT

New caramel compositions suitable for use with crisp bases such as cookies and crackers are provided. The new caramel compositions are able be packaged over long periods of storage in direct contact with a crisp base comprised of a cookie or cracker without adversely affecting the texture of either the crisp base or the caramel. They comprise a cooked mixture prepared from: liquid triglyceride, monosaccharide, disaccharide, polyol, milk solids, and emulsifier. The caramel exhibits an A_{w} of less than 0.42. Processing entails: mixing ingredients comprising liquid triglyceride, monosaccharide, disaccharide, polyol, milk solids, and emulsifier in a heating vessel; heating the ingredients to form a uniform heated mixture while scraping the vessel during heating to prevent scorching; and increasing the heat to boil the ingredients to a temperature and for a time to achieve caramelization.

### BACKGROUND OF THE INVENTION

The invention relates to new caramel compositions suitable for use with crisp food products such as cookies, crackers and bars with cereal pieces. The new caramel compositions are able be packaged over long periods of storage in direct contact with a crisp food without adversely affecting the texture of either the crisp base or the caramel.

Caramel as an ingredient in the food industry typically has a relative humidity (also referred to as water activity or A_{w}) of higher than 0.42. Direct application of caramel to foods meant to be crisp and having a relative humidity lower than 0.42 can cause shelf life problems due to migration of the moisture from the caramel to the base cake. This moisture migration will lead to softening of the basecake, sometimes to the point of sogginess. It can simultaneously cause the caramel to stiffen in texture.

In the past, the problem of moisture migration from caramel into a crisp base cake has been addressed by providing a fat-based moisture barrier. In this arrangement, a layer of a triglyceride fat of suitable composition and thickness would be applied to the basecake prior to application of a layer of caramel. Unfortunately, there are too many opportunities for failure of the barrier layer during processing and storage. Also, the application of a moisture barrier requires extra processing and processing equipment. And, even with care and extra equipment, failure of the barrier layer occurs too often, with the result being a product that is spoiled texturally. Product failures which are detected before distribution are expensive. Failures not caught until after distribution can be more costly because the customer may never buy the product again.

U.S. Pat. No. 6,713,102, to Conti, et al., for example, provides a barrier material to protect a crisp wafer. They point out that any conventional food-acceptable moisture barrier may be used. Preferably, they propose a fat-based moisture barrier such as chocolate or chocolate. They note that when the confectionery product comprising the sugar wafer is used in direct contact with a confectionery material, the confectionery material preferably has a low water activity, for example, a water activity below 0.5 and preferably below 0.3.

Moreover, moisture barriers are not fully effective over long storage times where the caramel is not fully enrobed with the barrier. The presence of the high relative humidity caramel in the same closed container as a cookie could cause a crisp texture of the cookie to be lost due to transfer of moisture from one component to the other by the headspace air. Clearly, many products require a more complete and predictable solution to the problem.

The need for barrier layers could also limit the type of products that could be adapted to the presence of a moist caramel filling or coating. In some cases, the fat layer would be incompatible with the caramel or the crisp food in terms of flavor or texture. In yet other cases, the need for a fully or partially hydrogenated fat would be a deterrent to consumption by some consumers. There is clearly a need for improvements that would enable the use manufacture of composite products containing a crisp food and a caramel confection.

The art of preparing true caramel candy includes cooking sugar, milk, and fat to prepare any of the various kinds of caramel, including wrapped caramels, plastic cast caramels, cast grained caramels, semi-short chocolate caramels, caramel coating for nougat rolls, summer-type chocolate caramels, and the like as described, for example, by J. J. Alikonis, CANDY TECHNOLOGY, AVI Publishing Co., 1983, pages 147, et sec. Caramel candies of these types have not permitted the preparation of all of the various types of caramel-flavored confections as would be desired. The moisture is typically significant in the formation of this soft candy, resulting in an A_{w} of above about 0.42. Efforts to reduce the moisture to lower levels for various purposes and to include hydrogenated or partially hydrogenated fats to make them suitable as coatings, cannot be accomplished without having an effect on texture and can also affect flavor.

The production of coatings for ice cream and the like has the opposite problem, in that the ice cream has a high moisture content. U.S. Pat. No. 2,122,016 to Stokes describes caramel ice cream coatings that can be applied to ice cream without becoming soggy. According to that process a mixture of sugar and milk is heated to caramelization, followed by mixing in another vessel to “grain” and dry the mixture. This “grained” caramel is then mixed with a small amount of fat until a dough-like mass is formed. This dough-like mass is ground through a refiner and the resulting product is then blended with additional fat to form the coating material. The texture of the product is due primarily to the fat having finely ground candy therein. It does not have a caramel texture and the bland fat is also a taste modifier.

The Stokes process has a number of practical problems beyond flavor and texture. For one, the “graining” process requires high-powered mixers to transform a viscous caramel into a dry granular material. Also, the final compositions prepared in this manner are difficult to stabilize in their fluid state. While the product is of low moisture and low relative humidity, it does not a caramel flavor and texture that can be considered natural.

U.S. Pat. No. 5,384,148 to Lynch, et al., discusses problems with the Stokes product in the discussion of another process for preparing a nontraditional caramel confection. Lynch, et al., describe the preparation of caramel confections which are said to facilitate coating, depositing, molding and baking. Like those of Stokes, these are prepared from a finely divided solid candy phase dispersed within a continuous fat phase. These products again differ from conventional caramel products which are based on sugars and milk protein and typically exhibit a chewy texture. The products of Lynch, et al., are essentially dry with powdered caramel mixed with fat and an emulsifier.

The Lynch, et al., process calls for preparing a powdered caramel brittle material by sheeting, cooling and grinding a caramel prepared by cooking aqueous milk solids with sugar to a moisture level of below 6%. Then, from 5 to 35% of the powdered caramel brittle is mixed with 30 to 60% granulated sugar, 17 to 40% fat, and 10 to 25% milk solids. The mixture is refined to obtain an average particle size of 0.0004 to 0.0020 inches, mixed with an emulsifying agent and additional vegetable fat, and heated to reduce the moisture level to a level (about 0.8% in the Example) suitable for using the confection as a coating. The flavor is said to be caramel like, but the texture is clearly different from caramel.

Other oil-based coatings are described by Hoffman in U.S. Pat. No. 2,524,291. These coatings can be employed as toppings or casings for ice cream, confectionery and other foods. The process employs water-soluble colors in combination with a water-in-oil emulsifying agent, such as lecithin, to provide coatings with a wide variety of colors, each being uniform in appearance. Among the colors mentioned is a brownish tint, formed by a combination of red, yellow and blue U.S. certified colors, useful for coloring a butterscotch or caramel flavored coating. The flavor compositions for these coatings are not identified. Separation of fat from caramel is not mentioned because real caramel is not employed. The flavor might be adjusted to taste like caramel, but not true caramel, and the texture is of a fatty coating, not of true caramel.

In U.S. Pat. No. 3,677,771, Kolar describes the preparation of a caramel-type confectionery product from a reconstitutable condensed milk product. A calcium sequestering agent is employed to avoid the typical loss in texture normally encountered when this type of milk is employed. The texture of the caramels produced is said to be of the character produced by conventional processing and the moisture content and relative humidity will also be near conventional, making the Kolar caramel confections unsuitable for use with crisp basecakes and other like foods.

A number of other variations on the typical caramel texture have been developed for special applications, however, development of specialty products necessarily limits their general usefulness. For example, in U.S. Pat. No. 4,927,645, Lee describes the preparation of a candy coating for snack food. The product is similar to caramel corn, and is thus seen as distinctly different in texture from the caramel so desired by many consumers, but incompatible with crisp cookies or crackers.

Thus, there remains a need in the art for caramel products that can be packaged with normally crisp products, such as cookies and biscuits, without detracting from the texture of the crisp portion, combinations of caramel and a crisp portion and processes for their preparation.

### SUMMARY OF INVENTION

Accordingly, it is an object of this invention to provide caramel confections and a process for making them, wherein the caramel exhibits the true flavor and texture of traditional caramel yet which are capable of packaging in the presence of crisp food products.

It is another object of this invention to provide caramel confections and a process for making them, wherein the caramel confections have the true flavor and texture of traditional caramel, but yet which can be packaged with crisp foods for long periods of time, with both the caramel and the crisp food retaining a desirable texture and strong textural contrast.

It is a more specific object of this invention to provide caramel confections having the true flavor and texture of caramel yet which are capable of packaging in direct contact with of crisp foods such as basecakes made of cookies or crackers.

It is yet another specific object of this invention to provide caramel confections having the true flavor and texture of caramel, capable of packaging in direct contact with of crisp foods, such as basecakes and cereals, without experiencing flavor or texture anomalies due to the presence of special barrier layers or other incompatible product additions.

It is a more specific object of preferred aspects of this invention to provide a process for preparing a shelf-stable combination of caramel confection having the true flavor and texture of caramel and a crisp base food such as a cereal, cookie or cracker product.

These and other objects are realized by the present invention, which provides caramel products that can be packaged with normally crisp base foods without detracting from the texture of the crisp base portion, combinations of caramel and a crisp base portion and processes for their preparation.

In one aspect of the invention, a caramel composition suitable for use with a crisp, baked dough product is provided and comprises a cooked mixture prepared from: liquid fat, monosaccharides, disaccharide, polyol, milk solids, and emulsifier, wherein the composition exhibits an A_{w} of less than 0.42, preferably less than 0.40.

In another aspect of the invention, a process is provided for preparing a caramel composition as defined above, the process comprising: cooking a mixture of liquid triglyceride, monosaccharides, disaccharide, polyol, milk solids, and emulsifier, to achieve a composition exhibiting an A_{w} of less than 0.42, preferably less than 0.40, and the ability to be packaged for extended times in the presence of a crisp base food.

In another aspect of the invention, a process is provided for preparing a caramel and crisp basecake composite product comprising contact at least one discrete region of a caramel as described above with at least one discrete region of a crisp basecake.

In yet another aspect, the invention provides products as described above, packaged in sealed containers.

Other preferred aspects of the invention will be detailed below.

### DETAILED DESCRIPTION OF THE INVENTION

The invention will be described below with specific reference to preferred caramel and composite products, and preferred processing techniques. However, it will be clear to the skilled food scientist that the principles that enable improvements in these will apply to other products as well.

The invention provides caramel compositions suitable for use with a crisp, e.g., baked dough or cereal product, referred to herein as a crisp base. These crisp base portion of the products are typically in the form of a cookie, cracker or crisp cereal of the ready-to-eat variety and are suitable for consumption without any filling or coating, but are conventionally available as distinct products and as composites. These crisp base portions exhibit crisp textures, typically being friable and short in texture. They typically have A_{w} values of less than 0.40, and often within the range of from 0.15 to 0.35, as appropriate for the nature of the basecake. The texture can be that of any of the types known as or associated with crisp cookies, crackers, biscuits, pastries, flaked, puffed and/or toasted cereals, and the like. The typical formulations and processing for crisp base portions of this type are well known to those skilled in the art, but a representative crisp base variety will be described in some greater detail follow a description of the caramel confection of the invention.

In general, the caramel confection of the invention will be comprised of the sugars and milk products necessary to obtain a true caramel flavor and texture. The composition will comprise a cooked mixture prepared from liquid fat, monosaccharides, disaccharides, milk solids, polyol and emulsifier. In addition, various flavors, salt and other seasonings and colors can be employed as desired. A preferred formulation will contain, prior to cooking to achieve an A_{w} value of less than 0.40: from 10 to 30% of a liquid triglyceride, from 10 to 30% monosaccharides, from 10 to 30% disaccharide, from 10 to 20% polyol, from 10 to 30% milk solids, and emulsifier, all percentages being by weight. Moisture contents of from 5 to about 25% can be effective with lower levels within this range, e.g., less than 20%, being preferred for the caramel confection compositions of the invention. The compositions should have enough liquid to permit process, but not so much water that caramelization of the sugars is prolonged.

Caramel, to have the true flavor and texture, must contain milk solids. The milk solids can be provided from any suitable source, but are preferably provided by the invention as a combination of condensed whole milk and dried whole milk so that the moisture content is not excessive during the cooking step. Too much moisture will unduly extend the cooking time. The preferred compositions of the invention will contain from 10 to 30% milk solids in the form of dried whole milk and sweetened whole condensed milk. The sweetened whole condensed milk will typically be supplied with a concentration of sugars of from about 35 to about 50%, and a moisture content of from about 25 to about 35%. Other milk solids sources, such as milk solids non fat, whey protein, whey protein concentrate, and the like, can also be employed, as can whole milk, skimmed milk, partially defatted milk and fortified milk. The milk solids will be adjusted as necessary to obtain the true caramel texture and flavor afforded by the invention.

The texture of the products of the invention is also achieved, in part, through the use of a normally liquid fat. Preferred products of the invention will contain from about 10 to about 30% liquid triglyceride. The liquid fat can be from any suitable source, whether natural or synthesized, but importantly is preferably liquid at consumption temperature, e.g., 15° to 35° C. and more narrowly 20° to 30° C., containing less than about 10% solids. Preferred fats can comprise any of the usual vegetable oils, preferably not hydrogenated, but can also be partially-hydrogenated or fully hydrogenated oils, but only in part, such as soybean, safflower, sunflower, high oleic sunflower, sesame, peanut, corn, olive, rice bran, babassu nut, palm, mustard seed, cottonseed, poppyseed, low erucic rapeseed, high erucic rapeseed, shea, marine, meadowfoam and the like oils. Synthesized and rearranged fats can also be employed. Preferred oils contain at least about 70%, preferably at least about 75%, C₁₈ acid residues (e.g., stearic, oleic, linoleic) and comprise oils such as peanut oil, olive oil, soybean oil, canola oil, sesame oil, and corn oil are especially desirable for some embodiments. If desired, incomplete esters and derivatives, sugar esters and waxes can be employed in amounts consistent with the objectives of the invention. It is a characteristic of the invention that the products have higher fat contents than normal for caramel products. The selection of the fat, emulsifier and contents of each of them permit the advantageous results of the invention to be achieved.

The compositions of the invention will also contain monosaccharides and disaccharides. Preferably, the caramel confection compositions of the invention will contain from 10 to 30% of one or more monosaccharides and from 10 to 30% of one or more disaccharides. The sugars will be maintained in solution to a great extent at low moisture contents or will otherwise be maintained suspended or in a supersaturated state which resists crystallization and graininess. With these as guidelines, the person skilled in the art is free to select sugars from among those known useful for food formulation. Thus, the term “sugar” is to be understood as meaning any of a number of useful saccharide materials. Included in the list of useful sugars are the mono-saccharides, disaccharides and polysaccharides and their degradation products; e.g., pentoses, including aldopentoses, methylpentoses, keptopentoses, like xylose and arabinose; a deoxyaldose like rhamnose, hexoses and reducing saccharides such as aldo hexoses like glucose, galactose and mannose; the ketohexoses, like fructose and sorbose; disaccharides, like lactose and maltose; non-reducing disaccharides such as a sucrose and other polysaccharides such as dextrin and raffinose; and hydrolyzed starches which contain as their constituents oligosaccharides. A number of sugar syrups, including corn syrup, high fructose corn syrup, molasses, and the like, are common sources as are various granular and powdered forms.

An important ingredient to assure processing efficiency and shelf stability is an emulsifier, present in an amount effective for these purposes. Preferred compositions will contain from 1 to 5% of a suitable emulsifier, such as sodium stearoyl-2-lactylate (SSL). Among other emulsifiers having suitable functionality are those characterized by the ability in the compositions of the invention to promote the formation of emulsions for the composition of the invention.

The preferred emulsifiers will typically have high HLB values (e.g., above about 10) in a system wherein calculated values are determined by the formula HLB=20(1−S/A), where S is the saponification number of the emulsifier ester and A is the acid number of the acid residue in the molecule. In certain cases, where accurate determination of the saponification number is difficult, the relationship HLB=(E+P)/5 is used, where E is the weight percent of oxyethylene and P is the weight percent of polyhydric alcohol. When ethylene oxide is the only hydrophilic group present the equation is reduced to HLB=E/5. Surfactants with lower HLB values are more hydrophobic, and have greater solubility in oils, whereas surfactants with higher HLB values are more hydrophilic, and have greater solubility in aqueous mediums. HLB numbers for emulsifiers above about 10 can be effective, as well as anionic, cationic, or zwitterionic compounds for which the HLB scale is not generally applicable, but those with higher values are preferred. HLB values may not accurately reflect the true physical chemical nature of the compounds. Also, commercial surfactant products are generally not pure compounds, but are often complex mixtures of compounds, and the HLB value reported for a particular compound may more accurately be characteristic of the commercial product of which the compound is a major component. Different commercial products having the same primary surfactant component can, and typically do, have different HLB values. In addition, a certain amount of lot-to-lot variability is expected even for a single commercial surfactant product. Keeping these inherent difficulties in mind, and using HLB values as a guide, one skilled in the art can readily identify surfactants having suitable hydrophilicity or hydrophobicity for use in the present invention, as described herein.

Among other surfactants that can be employed, alone or in combination are sodium stearoyl-2-lactylate and other acylactylates, among other emusifiers, including those known to be suitable for the different purpose of dough conditioning, e.g., poloxyethylene sorbitan monostearate, polyoxyethylene sorbitan monooleate, poloxyethylene sorbitan monolaurate, calcium/sodium stearoyl-2-lactylate (CSSL), diacetyl tartaric acid esters of monoglyceride (DATEM), glycerol monostearate (GMS) and distilled glycerol monostearate (DGMS) surfactant gels. In some compositions, the emulsifier can include a mixture of two or more hydrophilic surfactants, more preferably two or more non-ionic hydrophilic surfactants. Also preferred are mixtures of at least one hydrophilic surfactant, preferably non-ionic, and at least one hydrophobic surfactant.

The caramel confection compositions of the invention will also include significant concentrations of polyol, unlike conventional caramel. Preferred compositions will contain, prior to cooking, from 10 to 20% polyol. Suitable for use as the plasticizing agent are any of the normally liquid, edible di-, or trihydric alcohols or sugar alcohols or other polyhydric alcohols of suitable flavor and effective for this purpose. Prominent among these are glycerol and sorbitol, but others of this class and mixtures of these can be employed, for example hydrogenated starch hydrolysates and hydrogenated polydextrose. It has been found that due to its highly effective plasticizing effect and its flavor, glycerol is a preferred material. As with the liquid sugar component, the liquid polyol can be added as a liquid or aqueous solution or in dry form and hydrated by other water added to form the continuous aqueous liquid component. The combined weight of sugars and liquid polyols desirably amounts to from 25 to 60% weight of the composition prior to cooking.

Processing the above ingredients to prepare the caramel compositions of the invention is typical for caramel. In general, the process entails mixing ingredients comprising liquid triglyceride, monosaccharide, disaccharide, polyol, milk solids, and emulsifier in a heating vessel; heating the ingredients to form a uniform heated mixture while scraping the vessel during heating to prevent scorching; and increasing the heat to boil the ingredients to a temperature and for a time to achieve caramelization.

In a preferred procedure, all ingredients are weighed and added to a suitable heating vessel, such as a heated, stirred kettle. The ingredients are mixed together and warm to 150 to 160° F. over a low heat from a jacket, flame or the like. It is preferred to constantly scrape the side of the kettle during heating to prevent scorching. The heating is continued with mixing and scraping for a suitable period of time to dissolve the sugar and emulsify the fat, maintain the temperature at 150 to 160° F., typically from 5 to 30 minutes. Once the consistency and temperature of the mixture of ingredients is uniform, it is preferred to increase the heat and boil slowly, to a suitable temperature, e.g., about 235° F. The batch is then boiled to develop sufficient caramelization (continue mixing and scraping), e.g., for from about 10 to about 15 minutes.

The resulting cooked and caramelized mixture is then ready for further processing, such as cooling, cutting and/or packaging in any manner effective to retain the product attributes important to products of the type described. If desired, it can be immediately spread onto a basecake or can be cooled, held and reheated as necessary for later use. It will preferably have an A_{w} of below about 0.42, preferably less than 0.40. Indeed, the water activity can be as low as possible consistent with proper texture, as assessed by an expert panel. The A_{w} can be at lower levels, such as from 0.10 to 0.35. The moisture content of the final product need not be monitored as long as the water activity is assured. For suitable products, the moisture content will be low, say less than 5%, e.g., of from about 1 to about 3%.

The crisp base portions used in the composite products of the invention are prepared by baking a dough or processing a ready-to-eat cereal, as known in the art. The term “dough” as used in this context includes all formulations that the person skilled in the art would consider dough. At a minimum, these formulations contain a starch component and at least sufficient water to hydrate the starch, both being employed in reasonable proportions. The baked dough will typically be comprised of a starch component, a protein component and sufficient water for hydration. Cookies, as well as some crackers, will also contain some form of shortening and sugar or other sweetener.

The crisp base can be provided in a cake dough, which can be in any suitable commercial form, such as for forming a basecake for a cookie or the like. The starch component for such a basecake dough can be provided as whole grain or grain ground or refined to any desired degree. It can be supplied in the form of flour, e.g., from wheat, barley, corn, oats, rice, rye, treacle, and the like. Or, the starch component can be supplied as a purified or mechanically refined or less than whole grain flour. The water can comprise water itself or an aqueous liquid such as milk (whole, skim, homogenized, buttermilk, soy), fruit or vegetable juice, and the like. Yeast or chemical leavenings are also typically present. Also typically, the dough will contain shortening in an amount suitable for achieving the textural characteristics desired for a given type of product. Also typical, is the use of at least some sweetener, though in limited amounts compatible with savory flavors. Sucrose and corn syrup are among the most typical. All conventional ingredients, typical for desired recipes, can be employed. For the sake of economy of description, the entire text of Manley, J. R.; Technology of Biscuits, Crackers and Cookies, Vols. 1 and 2, is incorporated herein by reference for its descriptions of conventional ingredients and processing.

Doughs for baking into a crisp base, e.g., basecake can be formed on any of the equipment conventional, including laminators, extruders, depositors, rotary formers, wire cutters, and the like. Once the dough preform is formed, the sweet product of the invention can be applied onto or into a dough preform in any manner suitable and the resulting composite baked or otherwise cooked, e.g., fried, extruder heated, drum heated, or the like. The caramel of the invention is desirably added to a crisp base after the dough has been baked the baking process will be conventional as will the baking apparatus employed.

The following examples are provided to further illustrate and explain preferred forms of the invention and are not to be taken as limiting in any regard. Unless otherwise indicated, all parts and percentages are by weight.

### EXAMPLE 1

The following ingredients are mixed, by the procedure that follows, to form a caramel confection of the invention.

| Ingredient | Formula (g) | Formula (Wt. %) |
|---|---|---|
| Spray Oil | 120.0 | 21.99% |
| Corn Syrup, 43 DE | 85.0 | 15.58% |
| Sugar, White Granulated | 85.0 | 15.58% |
| Sweetened Condensed Whole Milk | 77.5 | 14.20% |
| Glycerin | 75.0 | 13.74% |
| Fructose powder | 70.0 | 12.83% |
| Whole Milk Powder | 25.0 | 4.58% |
| Salt | 4.7 | 0.86% |
| Sodium Stearoyl-2-Lactylate (SSL) | 2.5 | 0.46% |
| Vanilla Flavor #7 | 1.0 | 0.18% |
| Total | 545.7 | 100.00% |

The above ingredients are then processed as follows:
1. Weigh all ingredients into a kettle equipped with a gas heater and a mixer.
2. Mix together and warm to 150 to 160° F. over a low flame. Constantly scrape the side of the kettle to prevent scorching.
3. Continue mixing and scraping for 10 minutes to dissolve the sugar and emulsify the fat, maintain the temperature at 150 to 160° F.
4. Increase the heat (gas flame) and boil slowly to 235° F. The batch should be boiled for about 10 to 15 minutes to develop sufficient caramelization (continue mixing and scraping).
6. Spread the batch over a sheet to make ½ to ¾ inch thick sheet.
7. Heat a portion of the batch of the resulting caramel and apply to sugar wafers.

The above description is intended to enable a person skilled in the art to practice the invention. It is not intended to detail all of the possible modifications and variations, which would become apparent to the skilled worker upon reading the description. It is intended, however, that all such modifications and variations be included within the scope of the invention, which is defined by the following claims. The claims are meant to cover the indicated elements and steps in any arrangement or sequence that is effective to meet the objectives intended for the invention, unless the context specifically indicates the contrary.

1. A caramel composition suitable for use with a crisp base, comprising a cooked mixture prepared from: liquid triglyceride, monosaccharide, disaccharide, polyol, milk solids, and emulsifier, wherein the composition exhibits an A_{w} of less than 0.42.

2. A caramel composition according to claim 1, comprising corn syrup and fructose as monosaccharides.

3. A caramel composition according to claim 1, comprising sucrose as a disaccharide.

4. A caramel composition according to claim 5, wherein the combined weight of saccharides and polyol is from 25 to 60% weight of the composition prior to cooking.

5. A caramel composition according to claim 5, wherein the moisture content of the caramel composition is less than 5% following cooking.

6. A caramel composition suitable for use with a crisp base, comprising a cooked mixture prepared from:
from 10 to 30% of a liquid triglyceride,
from 10 to 30% monosaccharides,
from 10 to 30% disaccharide,
from 10 to 20% polyol,
from 10 to 30% milk solids, and
emulsifier, all percentages being by weight,
wherein the composition exhibits an A_{w} of less than 0.40.

7. A caramel composition according to claim 6, comprising corn syrup and fructose as the monosaccharides.

8. A caramel composition according to claim 6, comprising sucrose as the disaccharide.

9. A caramel composition according to claim 6, comprising condensed milk and dried milk powder as the milk solids.

10. A caramel composition according to claim 6, wherein the moisture content of the caramel composition is less than 5% following cooking.

11. A composite product comprising with caramel composition as defined in claim 1 having at least one discrete piece of basecake in contact therewith.

12. A process for preparing a caramel composition suitable for use with a crisp, baked dough product, comprising: mixing ingredients comprising liquid triglyceride, monosaccharide, disaccharide, polyol, milk solids, and emulsifier in a heating vessel; heating the ingredients to form a uniform heated mixture while scraping the vessel during heating to prevent scorching; and increasing the heat to boil the ingredients to a temperature and for a time to achieve caramelization.

13. A process for preparing a composite product by combining at least one discrete region of a caramel as described in claim 1 above, with at least one discrete region of a baked dough.

14. A product of the process of claim 12.

15. A product of the process of claim 13.
